(19) United States
(12) Patent Application Publication
(10) Pub. No.: US 2025/0206568 A1
(43) Pub. Date: Jun. 26, 2025

(54) SYSTEM AND METHOD FOR PREDICTING THE NEED FOR MAINTENANCE OF AT LEAST ONE COMPONENT OF AN ELEVATOR SYSTEM OR OF A PEOPLE CONVEYOR

(71) Applicant: OTIS ELEVATOR COMPANY, Farmington, CT (US)

(72) Inventor: Mustapha Toutaoui, Berlin (DE)

(21) Appl. No.: 18/895,553

(22) Filed: Sep. 25, 2024

(30) Foreign Application Priority Data
Dec. 21, 2023 (EP) 23219222.9

(51) Int. Cl. B66B 5/00; B66B 25/00

(52) U.S. Cl. CPC B66B 5/0025; B66B 25/006

(57) ABSTRACT

A monitoring system for predicting a need for maintenance of at least one component of an elevator system or of a people conveyor comprises at least one detector that detects or measures at least one operational parameter of at least one operation of the at least one component of the elevator system or of the people conveyor Also, at least one monitor checks whether the operational parameter is outside at least one predefined parameter range, and at least one counter increases or decreases at least one counter value in case the operational parameter is outside the at least one predefined parameter range. At least one comparator compares the at least one counter value with at least one predefined counter limit, and at least one alert generator issues an alert if the at least one counter value exceeds or falls below the at least one predefined counter limit.

### CROSS-REFERENCE TO RELATED APPLICATION

This application is a U.S. non-provisional application claiming the benefit of European Application No. 23219222.9, filed on Dec. 21, 2023, which is incorporated herein by reference in its entirety.

### TECHNICAL FIELD

The disclosure relates to elevator systems and to people conveyors, in particular to the maintenance of elevator systems and of people conveyors. The disclosure relates in particular to a system and to a method for predicting the need for maintenance of at least one component of an elevator system or of a people conveyor. In the following, a component of an elevator system or of a people conveyor will be shortly denoted as a “component”.

### BACKGROUND

People conveyors for conveying people in buildings and similar structures may include escalators and moving walkways.

Elevator systems and people conveyors comprise at least one movable conveyance component, such as an elevator car or a chain of steps of pallets, for conveying passengers between a plurality of landings. An elevator system as well as a people conveyor further comprise a plurality of functional components, such as a drive for moving the movable conveyance component, at least one brake for braking the movement of the movable conveyance component, and/or door drives for opening and closing doors.

Reliable operation of all functional components is necessary in order to ensure a reliable operation of the elevator system and of the people conveyor. A malfunction of at least one of the functional components may result in an unscheduled interruption of the operation of the elevator system or of the people conveyor, which is unpleasant to the users. In a worst case, a malfunction of at least one of the functional components may result in passengers being held for an extended period of time within the elevator system or within the people conveyor, for example in an elevator car of the elevator system.

### SUMMARY

A monitoring system and a method are provided, which allow for optimizing maintenance of an elevator system and/or of a people conveyor, in particular by reducing the need for in person maintenance and simultaneously reducing an unscheduled interruption of the operation of the people conveyor due to a malfunction of an component of the elevator system or of the people conveyor.

According to an exemplary embodiment of the disclosure, an monitoring system is configured for predicting the need for maintenance of at least one component of an elevator system or of a people conveyor by monitoring at least one operational parameter of the at least one component. The monitoring system comprises at least one detector, which is configured for detecting or measuring at least one operational parameter of at least one operation of the at least one component; at least one monitor, which is configured for checking whether the at least one operational parameter is outside at least one predefined parameter range; at least one counter, which is configured for increasing or decreasing at least one counter value in case the at least one operational parameter is outside the at least one predefined parameter range; at least one comparator, which is configured for comparing the at least one counter value with at least one predefined counter limit; and at least one alert generator, which is configured for issuing an alert if the at least one counter value exceeds or falls below the at least one predefined counter limit. The alert may in particular include a maintenance message requesting maintenance of the at least one component.

Exemplary embodiments of the disclosure further include an elevator system comprising at least one movable conveyance component, in particular at least one elevator car, for conveying passengers between a plurality of landings; and at least one monitoring system according to an exemplary embodiment of the disclosure, which are configured for monitoring at least one operational parameter of at least one component of the elevator system. The elevator system may in particular comprise a plurality of monitoring systems according to exemplary embodiments of the disclosure, which are configured for monitoring different operational parameters of one or more components of the elevator system.

Exemplary embodiments of the disclosure further include a people conveyor, such as an escalator or a moving walkway, comprising at least one movable conveyance component, such as a chain of conveyance elements, for conveying passengers between a plurality of landings; and at least one monitoring system according to an exemplary embodiment of the disclosure, which are configured for monitoring at least one operational parameter of at least one component of the people conveyor. The people conveyor may in particular comprise a plurality of monitoring systems according to exemplary embodiments of the disclosure, which are configured for monitoring different operational parameters of one or more components of the people conveyor.

Exemplary embodiments of the disclosure also include a method for predicting the need for maintenance of at least one component of an elevator system or of a people conveyor by monitoring at least one operational parameter of the at least one component. The method comprising repeatedly detecting or measuring at least one operational parameter of at least one operation of the at least one component; checking, whether the at least one operational parameter is outside at least one predefined parameter range; increasing or decreasing a counter value in case the at least one operational parameter is outside the at least one predefined parameter range; comparing the counter value with at least one predefined counter limit; and issuing an alert if the counter value exceeds or falls below the at least one predefined counter limit. The alert may in particular include a maintenance message requesting maintenance of the at least one component.

Exemplary embodiments of the disclosure allow for predicting a need for maintenance of an component of an elevator system or of a people conveyor by monitoring the operation of at least one component, wherein the monitoring in particular includes detecting or measuring at least one operational parameter of at least one operation of the at least one component and counting the events in which the at least one operational parameter is detected to be outside a predefined parameter range, which has been set for the respective operational parameter. In particular embodiments, the monitoring may be carried at consecutive times, particularly in regular time intervals, and even continuously.

A single event, in which the at least one operational parameter is detected to be outside a predefined parameter range, may occur accidentally. The occurrence of a single event is therefore not a reliable indicator for a need for maintenance or replacement of a monitored component.

However, multiple occurrences of such events may be a strong indicator that there is a problem with the monitored component, indicating that said components should be maintained or replaced in order to prevent the occurrence of a malfunction, which may result in an unscheduled shutdown of the elevator system or of the people conveyor.

By setting the at least one predefined parameter range and the at least one counter limit, a monitoring system and a method for predicting the need for maintenance of at least one component of an elevator system or of a people conveyor according to exemplary embodiments of the disclosure may be adjusted individually to the at least one monitored component in order to optimize the prediction of the need for maintenance.

The at least one predefined parameter range and the at least one counter limit may be set based on past experiences with the at least one monitored component.

The at least one predefined parameter range and the at least one counter limit may be optimized even further during operation of the system by keeping records of the operation of the monitoring system according to an exemplary embodiment of the disclosure, and adjusting or re-adjusting the at least one predefined parameter range and/or the at least one counter limit based in the recorded data.

This can be done employing a dedicated elevator system or a dedicated people conveyor, which is installed for performing this task, or by using a model of an elevator system or of a people conveyor, which is provided in a test environment. The model may be a physical model, or a numerical model, which is included in a computational simulation of the elevator system or of the people conveyor. Setting the at least one predefined parameter range and the at least one counter limit may also include using data from a real elevator system or people conveyor in combination with data, which is provided by a model of the elevator system or people conveyor, respectively.

The efficiency and the reliability of the monitoring system and the method for predicting the need for maintenance of at least one component may be enhanced even further in that a respective parameter range and/or a respective counter limit are monitored during the service life of the system and re-adjusted, if appropriate.

A number of optional features are set out in the following. These features may be realized in particular embodiments, alone or in combination with any of the other features.

The people conveyor may also be an escalator or a moving walkway, wherein the at least one conveyance component includes a chain of conveyance elements, such as steps or pallets, extending in a longitudinal conveyance direction between two landings.

The monitoring system may be configured for resetting the at least one counter. The monitoring system may in particular be configured for resetting the at least one counter after the alert has been issued, and/or after maintenance has been performed.

Alternatively or additionally, the monitoring system may be configured for resetting the at least one counter after the counter value has exceeded or fallen below the at least one predefined counter limit.

Resetting the counter allows the monitoring system to start over in order to detect future events, which might indicate the need for maintenance of at least one component.

The at least one counter may be reset manually, for example by a mechanic, after completing maintenance of the system. This allows for resetting the at least one counter reliably only after the problematic component has been checked by a mechanic and a potential problem has been fixed, if necessary.

Alternatively or additionally, the at least one counter may be reset automatically in case the at least one counter value has not been changed for a predefined period of time or in case less than a predefined number of notifications have been issued in the predefined amount of time.

The fact that the at least one counter value was not or almost not changed for a predefined period of time may indicate that any previously detected events have been accidental events and/or that the detected potential problem does not exist anymore. Resetting the at least one counter may therefore prevent false alarms form being issued.

The at least one monitored operation of the at least one component may include the operation of a brake of the elevator system or of the people conveyor. The at least one operational parameter may, for example include an activation time and/or a release time of the monitored brake.

The at least one monitored operation of the at least one component may include the movement of at least one door of the elevator system. The at least one door may be a landing door, which is provided at a landing of the elevator system, or a door of an elevator car of the elevator system.

The at least one operational parameter, which is monitored by the monitoring system, may include an opening time and/or a closing time of the at least one door. The opening time and/or a closing time are important parameters for monitoring the condition of a door of the elevator system and a corresponding door drive, which is configured for moving the respective door. Unusual long opening times and/or unusual long closing times of an elevator door may be an indicator for problems of the elevator door and/or of the corresponding door drive, which need for maintenance in order to maintain a reliable operation of the elevator system.

The at least one monitored operation of the at least one component may include the operation of a drive of the elevator system or of the people conveyor, which is configured for moving the at least one movable conveyance component of the elevator system or of the people conveyor.

The at least one monitored operation of the at least one movable conveyance component may in particular include the operation of an elevator drive, which is configured for moving the at least one elevator car of an elevator system or a chain drive, which is configured for moving a chain of steps or pallets and/or a handrail of an escalator and/or of an moving walkway, respectively.

The at least one operational parameter may include an electric current flowing through an electric motor of the drive, when the drive is operated. The at least one operational parameter may in particular include an electric current flowing through the electric motor, when the drive is operated at its maximum speed.

An unusual large electric current flowing through the electric motor may be an indicator for a problem with the electric motor and/or with a problem with another portion of the drive and/or the drive train.

In the case of an elevator system, the at least one monitored operation of the at least one component of the elevator system may include employing a positioning system for positioning an elevator car at a predefined position within the hoistway, in particular a position at a predefined landing. The at least one operational parameter may in particular include a distance between the actual position of the elevator car, after it has been positioned by the positioning system, and the predefined position.

A positioning system, which allows for determining the current position of the elevator car and positioning the elevator car at a predefined position within the hoistway, in particular at a desired landing, is essential for a reliable operation of the elevator system. Positioning the elevator car as close as possible to the desired landing is desirable for preventing a step from being formed between the floor of the landing and the floor of the elevator car.

A monitoring system according to an exemplary embodiment of the disclosure may comprise multiple detectors. The multiple detectors may be configured for detecting and/or measuring different operational parameters of one or more operations of one or more components.

The monitoring system may further comprise multiple monitors and/or multiple counters and/or multiple comparators and/or multiple alert generators. In particular, a dedicated monitor, a dedicated counter, a dedicated comparator, and a dedicated alert generator may by assigned to each of the plurality of detectors, respectively.

The monitors, the counters, the comparators and the alert generators may be provided as individual components, which may, in particular, be provided as separate electric circuits.

In such an embodiment, the monitoring system may comprise a plurality of monitoring subsystems, which may operate independently of each other. As a result, a malfunction of one of the monitoring subsystems does not adversely affect the operability of the other monitoring subsystems. This allows for monitoring at least some operations of components, even if one of the monitoring subsystems fails.

Alternatively, the functionalities of the monitor, the counter, the comparator and the alert generator may be provided by a single electric circuit, in particular by an integrated electric circuit. The single electric circuit may, for example, include a microprocessor, which is configured running a program, which causes the microprocessor to provide the desired functionalities. The microprocessor and the program may in particular be configured for providing the functionalities of the monitor, the counter, the comparator and the alert generator for a plurality of detectors, in particular for a plurality of detectors monitoring the same component.

Integrating a plurality of functionalities in a single electric circuit, in particular in an integrated electric circuit, such as a microprocessor, may simplify the structure of the monitoring system. This may allow for reducing the costs for producing and maintaining the monitoring system. Employing an software program running on a microprocessor simplifies maintenance and optimizations of the monitoring system, as such changes may be implemented easily by changing the software program.

### BRIEF DESCRIPTION OF THE DRAWINGS

In the following, exemplary embodiments of the disclosure are described with reference to the enclosed figures.

FIG. 1 schematically depicts an elevator system according to an exemplary embodiment of the disclosure.

FIG. 2 schematically depicts a drive monitoring system according to an exemplary embodiment of the disclosure.

FIG. 3 schematically depicts a positioning system monitoring system according to an exemplary embodiment of the disclosure.

FIG. 4 schematically depicts a door drive monitoring system according to an exemplary embodiment of the disclosure.

FIG. 5 schematically depicts a brake monitoring system according to an exemplary embodiment of the disclosure.

FIG. 6 depicts a schematic side view of an escalator according to an exemplary embodiment of the disclosure.

FIG. 7 depicts a schematic side view of moving walkway according to an exemplary embodiment of the disclosure.

FIG. 8 schematically depicts a handrail monitoring system according to an exemplary embodiment of the disclosure.

### DETAILED DESCRIPTION

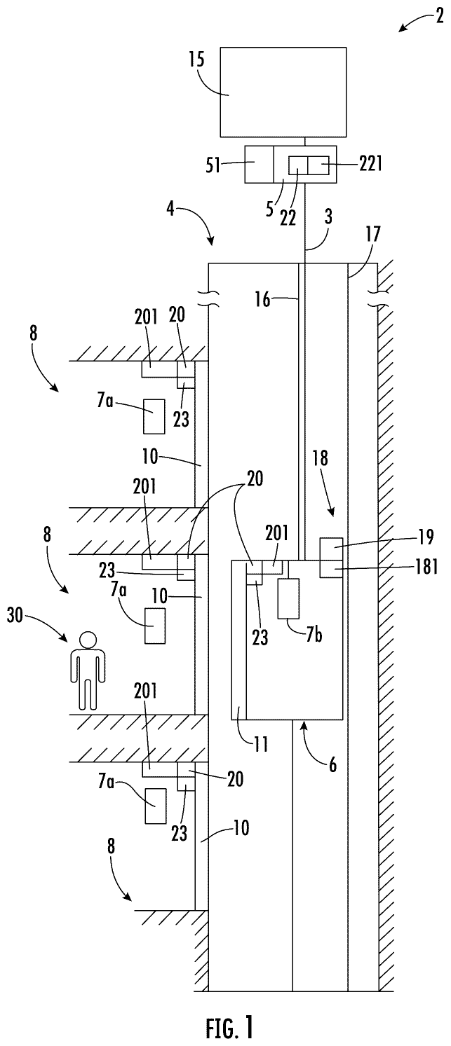

FIG. 1 schematically depicts an elevator system 2 comprising a monitoring system, in particular an elevator monitoring system, according to an exemplary embodiment of the disclosure.

The elevator system 2 comprises a hoistway 4 extending in a vertical direction between a plurality of landings 8 located on different floors.

The elevator system 2 further comprises an elevator car 6, which is configured for moving along the hoistway 4 between the plurality of landings 8.

The elevator car 6 may in particular be configured for moving along at least one guide member 16, such as a guide rail, extending along the vertical direction within the hoistway 4.

The elevator car 6 is movably suspended within the hoistway 4 by way of a tension member 3. The tension member 3, for example a rope or belt, is connected to an elevator drive 5, which is configured for driving the tension member 3 in order to move the elevator car 6 along the longitudinal direction/height of the hoistway 4 between the plurality of landings 8.

The exemplary embodiment of the elevator system 2 shown in FIG. 1 employs a 1:1 roping for suspending the elevator car 6. The skilled person, however, easily understands that the type of the roping is not essential for the disclosure and that different kinds of roping, e.g. a 2:1 roping, may be used as well. The elevator system 2 may further include a counterweight (not shown) moving concurrently and in opposite direction with respect to the elevator car 6. Alternatively, the elevator system 2 may be an elevator system 2 without a counterweight, as it is shown in FIG. 1. The elevator system 2 may have a machine room or may be a machine room-less elevator system. The elevator system 2 may use a tension member 3, as it is shown in FIG. 1, or it may be an elevator system without a tension member 3, comprising e.g. a hydraulic drive, or a linear drive (not shown).

The elevator drive 5 comprises at least one elevator brake 22, which is configured for selectively braking any movement of the elevator car 6 by interacting with the tension member 3. Alternatively or additionally, at least one elevator brake 22 for braking the movement of the elevator car 6 may be provided at the elevator car 6 itself. The at least one elevator brake 22 may, for example, be configured for engaging with the guide member 16 for braking any movement of the elevator car 6 with respect to the guide member 16.

Each landing 8 is provided with a landing door (elevator hoistway door) 10, and the elevator car 6 is provided with a corresponding elevator car door 11 allowing a passenger 30 to transfer between a landing 8 and the interior space of the elevator car 6 when the elevator car 6 is positioned at the respective landing 8.

The elevator system 2 further comprises door drives 20, which are configured for moving of the landing doors 10 and the elevator car door 11.

Separate door drives 20 may be provided for moving the landing doors 10 and the elevator car door 11, respectively.

Alternatively, a door drive 20, which is provided at one of the landings 8, may be configured for simultaneously moving the landing door(s) 10 at said respective landing 8 and the elevator car door 11 of the elevator car 6, when it is positioned at the respective landing 8.

In an alternative embodiment, a door drive 20, which is provided at the elevator car 6, may be configured for simultaneously moving the elevator car door 11 and the landing door(s) 10 at a landing 8, at which elevator car 6 is currently positioned.

In the following, the term “elevator doors 10, 11” encompasses the elevator car door 11, the landing doors 10 and any combination thereof.

Every elevator door 10, 12 may be provided with a door sensor 23, which is configured for detecting whether the respective elevator door 10, 11 is open or closed.

The elevator drive 5 is controlled by an elevator controller 15 for moving the elevator car 6 along the hoistway 4 between the different landings 8.

Input to the elevator controller 15 may be provided via elevator hall call buttons 7a, which are provided on each landing 8 close to the elevator landing doors 10, and/or via elevator car control buttons 7b provided inside the elevator car 6.

The elevator hall call buttons 7a may include destination call buttons allowing passengers to enter their respective destinations before entering the elevator car 6. When the elevator hall call buttons 7a are provided as destination call buttons, no elevator car control buttons 7b need to be provided inside the elevator car 6.

The elevator hall call buttons 7a and the elevator car control buttons 7b may be connected to the elevator controller 15 with electrical lines, which are not shown in FIG. 1, in particular by an electric bus, e.g. a field bus such as a CAN bus, or by wireless data transmission.

In order to determine the current position of the elevator car 6, the elevator car 6 is provided with a positioning system 18 including, for example a position sensor 19 mounted to the elevator car 6. The position sensor 19 may, for example, interact optically or magnetically with a corresponding scale 17, which is stationary provided within the hoistway 4 in order to allow the positioning system 18 to detect the current position of the elevator car 6 within the hoistway 4.

Alternatively or additionally, the position sensor 19 may include a speed sensor and/or an acceleration sensor (not shown) for detecting the speed and/or the acceleration of the elevator car 6 within the hoistway 4. In this case, the position sensor 19 may be configured for determining the current position of the elevator car 6 within the hoistway 4 from the detected speed and/or the acceleration of the elevator car 6.

In an elevator system 2 according to an exemplary embodiment of the disclosure, the elevator drive 5 may be equipped with a drive monitoring system 51, which is configured for monitoring the operation of the elevator drive 5.

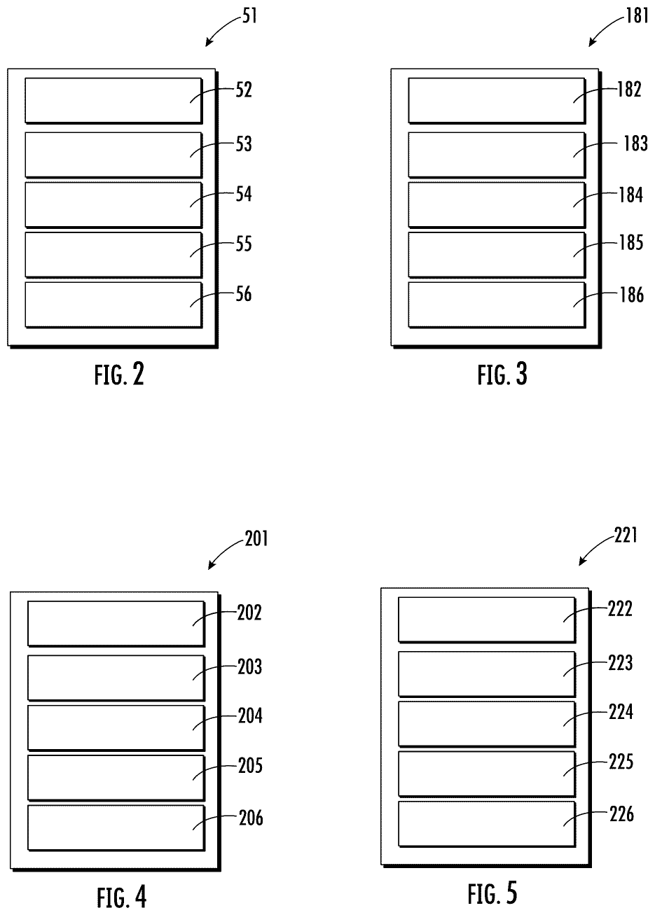

An enlarged schematic view of a drive monitoring system 51 according to an exemplary embodiment of the disclosure is depicted in FIG. 2.

The drive monitoring system 51 includes a drive detector 52 and a drive monitor 53. The drive detector 52 is configured for detecting at least one operational parameter of the drive 5. The drive monitor 53 is configured for checking whether the at least one operational parameter, which has been detected by the drive detector 52 is within or outside a predefined parameter range. It is further configured for issuing a notification in case the at least one operational parameter is outside the predefined parameter range.

The predefined parameter range may be limited at both ends, i.e. at its upper end and at its lower end. Alternatively, the predefined parameter range may be limited at only one end, in particular at its upper end, so that a notification is issued by the drive monitor 53 only if the at least one operational parameter exceeds a predefined limit, which corresponds to the upper end of the predefined parameter range.

The at least one operational parameter, which is detected by the drive monitoring system 51, may, for example, be an electric current, which is supplied to the elevator drive 5, when the elevator drive 5 is operated. In this case, the predefined parameter range may be a range of the electrical current, which is expected to be supplied to the elevator drive 5 in the course of normal operation. The drive monitor 53 may in particular be configured for issuing a notification in case the detected electric current supplied to the elevator drive 5 exceeds a predefined maximum electrical current, which is expected not to be exceeded in the course of normal operation.

Alternatively or additionally, the at least one operational parameter, which is detected by the drive monitoring system 51 may be a time period for which an electric current supplied to the elevator drive 5 exceeds a predefined current limit. In this case, the predefined parameter range may define a range of the time period, for which the electric current supplied to the elevator drive 5 is expected to exceed the predefined current limit.

The drive monitoring system 51 further includes a drive counter 54. The drive counter 54 is configured for increasing a counter value of the drive counter 54 every time the drive monitor 53 issues a notification indicating that the at least one operational parameter, which is monitored by the drive monitoring system 51, is outside the predefined parameter range.

The drive monitoring system 51 further includes a drive comparator 55, which is configured for comparing the counter value of the drive counter 54 with a predefined drive counter limit; and a drive alert generator 56, which is configured for issuing an alert in case the counter value of the drive counter 54 exceeds the predefined drive counter limit. The alert may include a drive maintenance message requesting maintenance of the elevator system 2, in particular maintenance of the elevator drive 5.

The drive monitoring system 51 may be configured for resetting the drive counter 54 to a starting value, when the counter value of the drive counter 54 exceeds the predefined drive counter limit,

In an alternative embodiment, the drive counter 54 may be configured for decreasing the counter value every time the drive monitor 53 issues a notification indicating that the at least one operational parameter, which is monitored by the drive monitoring system 51, is outside the predefined parameter range.

In such a configuration, the drive alert generator 56 is configured for issuing an alert, in case the counter value of the drive counter 54 falls below predefined drive counter limit. The predefined drive counter limit may, in particular, be zero.

The alert may include a drive maintenance message requesting maintenance of the elevator system 2, in particular maintenance of the elevator drive 5.

The drive monitoring system 51 may be configured for resetting the drive counter 54 to a starting value, when the counter value of the drive counter 54 falls below the predefined drive counter limit.

The drive counter 54 may also be reset to its starting value, for example by the drive alert generator 56, after and alert, in particular a drive maintenance message, has been issued.

Alternatively, the drive counter 54 may be reset manually by a mechanic after maintenance of the elevator system 2 has been completed.

Optionally, the drive counter 54 may be reset automatically in case no notification has been issued for a predefined period of time.

As a further option, the drive counter 54 may be reset automatically in case less than a predefined number of notifications have been issued in a predefined amount of time.

The positioning system 18 is equipped with a positioning system monitoring system 181, which is configured for monitoring the operation of the positioning system 18.

An enlarged schematic view of a positioning system monitoring system 181 according to an exemplary embodiment of the disclosure is depicted in FIG. 3.

The positioning system monitoring system 181 includes a positioning system detector 182, which is configured for detecting at least one operational parameter of the positioning system 18. The positioning system monitoring system 181 further includes a positioning system monitor 183, which is configured for checking whether the at least one operational parameter detected by the positioning system detector 182. is outside a predefined parameter range. The positioning system monitor 183 is further configured for issuing a notification in case the at least one operational parameter is outside the predefined parameter range.

The predefined parameter range may be limited on both ends, i.e. the upper end and the lower end of the predefined parameter range. Alternatively, the predefined parameter range may be limited at only one end, in particular at its upper end, so that a notification is issued by the positioning system monitoring system 181 in case the at least one operational parameter exceeds a predefined limit, which corresponds to the upper end of the predefined parameter range.

The at least one operational parameter, which is monitored by the positioning system monitoring system 181 may, for example, include a position of the elevator car 6 with respect to at least one of the landings 8.

After the elevator controller 15 has instructed the elevator drive 5 to move the elevator car 6 to a selected landing 8, and the elevator drive 5 has moved the elevator car 6 to said landing 8, an elevator car leveling system (not shown) may be employed for moving the elevator car 6 exactly to a predefined position within the hoistway 4, in particular exactly to a predefined position with respect to the respective landing 8, in order to prevent a step from being formed between the floor of the elevator car 6 and the floor of the respective landing 8.

The elevator car leveling system may comprise at least one leveling position sensor, which allows for determining the position of the elevator car 6 within the hoistway 4 with high accuracy.

The at least one leveling position sensor may be employed as the positioning system detector 182 for determining the position of the elevator car 6 with respect to one of the landings 8 with high accuracy, when the control of the elevator drive 5 is transferred from the positioning system 18 to the elevator car leveling system.

The parameter range may correspond to a range of allowable positions of the elevator car 6 with respect to one of the landings 8, when the control of the elevator drive 5 is transferred from the positioning system 18 to the leveling system. The positioning system monitor 183 may be configured for issuing a notification, in case the elevator car 6 is positioned outside the range of allowable positions of the elevator car 6 with respect to one of the landings 8, when the control of the elevator drive 5 is transferred from the positioning system 18 to the leveling system.

The door drive monitoring system 181 further includes a positioning system counter 184, which is configured for increasing a counter value of the positioning system counter 184 every time the positioning system monitor 183 issues a notification indicating that the at least one operational parameter, which is monitored by the positioning system monitoring system 181, is outside the predefined parameter range, i.e. when the elevator car 6 is positioned outside the range of allowable positions of the elevator car 6 with respect to one of the landings 8, when the control of the elevator drive 5 is transferred from the positioning system 18 to the leveling system.

The positioning system monitoring system 181 also includes a positioning system comparator 185, which is configured for comparing the counter value of the positioning system counter 184 with a predefined positioning system counter limit; and a positioning system alert generator 186, which is configured for issuing an alert in case the counter value of the positioning system counter 184 exceeds the predefined positioning system counter limit. The alert may include a positioning system maintenance message requesting maintenance of the elevator system 2, in particular maintenance of the positioning system 18.

In an alternative embodiment, the positioning system counter 184 may be configured for decreasing the counter value every time the positioning system monitor 183 issues a notification indicating that the at least one operational parameter, which is monitored by the positioning system monitoring system 181, is outside the predefined parameter range.

In such a configuration, the positioning system alert generator 186 is configured for issuing an alert in case the counter value of the positioning system counter 184 falls below the predefined positioning system counter limit. The predefined positioning system counter limit may, in particular, be zero. The alert may include a positioning system maintenance message requesting maintenance of the elevator system 2, in particular maintenance of the positioning system 18.

The positioning system monitoring system 181 may be configured for resetting the positioning system counter 184 to a starting value, when the counter value of the positioning system counter 184 exceeds the predefined positioning system counter limit or when the counter value of the positioning system counter 184 falls below the predefined positioning system counter limit.

The positioning system monitoring system 181 may be configured for resetting the positioning system counter 184 to a starting value, when after an alert, in particular an elevator drive maintenance message, has been issued and/or after a maintenance has been performed.

The positioning system counter 184 may be reset, for example, by the positioning system comparator 185, when the counter value of the positioning system counter 184 exceeds or falls below the predefined positioning system counter limit.

The positioning system counter 184 may be reset, for example, by the positioning system alert generator 186 after an alert, in particular a positioning system maintenance message has been issued.

Alternatively, the positioning system counter 184 may be reset manually by a mechanic after maintenance of the elevator system 2, in particular maintenance of the positioning system 18, has been completed.

Optionally, the positioning system counter 184 may be reset automatically in case no notification has been issued for a predefined period of time.

As a further option, the positioning system counter 184 may be reset automatically in case less than a predefined number of notifications have been issued in a predefined amount of time.

Each of door drives 20 of the elevator system 2 may equipped with a door drive monitoring system 201, which is configured for monitoring the operation of the respective door drive 20.

An enlarged schematic view of a door drive monitoring system 201 according to an exemplary embodiment of the disclosure is depicted in FIG. 4.

The door drive monitoring system 201 includes a door drive detector 202, which is configured for detecting at least one operational parameter of the associated door drive 20. The door drive monitoring system 201 further includes a door drive monitor 203, which is configured for checking whether the at least one operational parameter, which is detected by the door drive detector 202, is outside a predefined parameter range. The door drive monitor 203 is further configured for issuing a notification in case the at least one operational parameter is outside the predefined parameter range.

The predefined parameter range may be limited at both ends, i.e. at the upper end and at the lower end of the predefined parameter range. Alternatively, the predefined parameter range may be limited at only one end, in particular at its upper end, so that a notification is issued by the door drive monitoring system 201 in case the at least one operational parameter exceeds a predefined limit, which corresponds to the upper end of the predefined parameter range.

The at least one operational parameter, which is monitored by the door drive monitoring system 201, may, for example, include a door opening time period. The door opening time period may be defined as the time period needed for opening the elevator door(s) 10, 11, which are driven by the door drive 20. More particularly, the door opening time period may be defined by the time period, which starts at a first point in time when the respective door drive 20 is instructed to open the associated elevator door(s) 10, 11, and which stops at a second point in time, when the respective elevator door(s) 10, 11 is/are completely open.

Each of the elevator doors 10, 11 or of the door drives 20 may be provided with a door sensor 23 (see FIG. 1), which is configured for detecting whether the respective elevator door 10, 11 is completely open, and for providing an corresponding door open signal.

Alternatively or additionally, the at least one operational parameter. which is monitored by the door drive monitoring system 201 may, include a door closing time period, which is defined as the time period needed for closing the elevator door(s) 10, 11 driven by the door drive 20.

More particularly, the door closing time period may be defined by the time period, which starts at a third point in time, when the respective door drive 20 is instructed to close the associated elevator door(s) 10, 11, and which stops at a fourth point in time, when the respective elevator door(s) 10, 11 is/are completely closed.

Each of the elevator doors 10, 11 or of the door drives 20 may be provided with a door sensor 23, which is configured for detecting whether the respective elevator door 10, 11 is completely closed, and for providing a corresponding door open signal.

The same door sensor 23 may be configured for detecting, whether an associated elevator door 10, 11 is open or closed. Alternatively, a first door sensor 23 may be configured for detecting whether an associated elevator door 10, 11 is open, and a second door sensor 23, which is associated with the same elevator door 10, 11, may be configured for detecting whether an associated elevator door 10, 11 is closed. For simplicity and clarity of the illustration, only a single door sensor 23 is shown at each elevator door 10, 11 in FIG. 1.

The parameter ranges for the door closing time and the door opening time may be limited at their upper ends, defining a maximum door opening time or a maximum door closing time, respectively, which should not be exceed during normal operation of the elevator system 2.

The door drive monitoring system 201 further includes a door drive counter 204, which is configured for increasing a counter value of the door drive counter 204 every time the door drive monitor 203 issues a notification indicating that the at least one operational parameter, which is monitored by the door drive monitoring system 201, is outside the predefined parameter range.

The door drive monitoring system 201 also includes a door drive comparator 205, which is configured for comparing the counter value of the door drive counter 204 with a predefined door drive counter limit; and a door drive alert generator 206, which is configured for issuing an alert, in particular including door drive maintenance message requesting maintenance of the elevator system 2, in particular maintenance of the door drive 20 an/or of the elevator doors 10, 11, in case the counter value of the door drive counter 204 exceeds the predefined door drive counter limit.

In an alternative embodiment, the door drive counter 204 may be configured for decreasing the counter value every time the door drive monitor 203 issues a notification indicating that the at least one operational parameter, which is monitored by the door drive monitoring system 201, is outside the predefined parameter range.

In such a configuration, the door drive alert generator 206 is configured for issuing an alert, in particular a door drive maintenance message requesting maintenance of the elevator system 2, more particularly maintenance of the door drive 20 an/or of the elevator doors 10, 11, in case the counter value of the door drive counter 204 falls below the predefined door drive counter limit. The predefined door drive counter limit may, in particular, be zero.

The door drive monitoring system 201 may be configured for resetting the door drive counter 204 to a starting value, when the counter value of the door drive counter 204 exceeds the predefined door drive counter limit or when the counter value of the door drive counter 204 falls below the predefined door drive counter limit. The door drive monitoring system 201 may be configured for resetting the door drive counter 204 to a starting value, when after the alert has been issued and/or after a maintenance has been performed.

The door drive counter 204 may be reset, for example, by the door drive comparator 205, when the counter value of the door drive counter 204 exceeds or falls below the predefined door drive counter limit.

The door drive counter 204 may be reset by the elevator door drive alert generator 206 after an alert, in particular a door drive maintenance message, has been issued.

Alternatively, the door drive counter 204 may be reset manually by a mechanic after maintenance of the elevator system 2, in particular maintenance of the door drive 20 an/or of the elevator doors 10, 11, has been completed.

Optionally, the door drive counter 204 may be reset automatically in case no notification has been issued for a predefined period of time.

As a further option, the door drive counter 204 may be reset automatically in case less than a predefined number of notifications have been issued in a predefined amount of time.

The brake 22 may be equipped with a brake monitoring system 221, which is configured for monitoring the operation of the brake 22.

An enlarged schematic view of an brake monitoring system 221 according to an exemplary embodiment of the disclosure is depicted in FIG. 5.

The brake monitoring system 221 includes an brake detector 222, which is configured for detecting at least one operational parameter of the brake 22. The brake monitoring system 221 further includes an brake monitor 223, which is configured for checking whether the at least one operational parameter, which is detected by the brake detector 222, is outside a predefined parameter range. The brake monitor 223 is further configured for issuing a notification in case the at least one operational parameter is outside the predefined parameter range.

The predefined parameter range may be limited at both ends, i.e. at its upper end and at its lower end. Alternatively, the predefined parameter range may be limited at only one end, in particular at its upper end, so that a notification is issued by the brake monitoring system 221 in case the at least one operational parameter exceeds a predefined limit, which corresponds to the upper end of the predefined parameter range.

The at least one operational parameter, which is monitored by the brake monitoring detector 222 may, for example, include an activation time and/or a release time of the brake 22.

The activation time of the brake 22 may be defined as the time period between a first point in time, at which the brake 22 is triggered, e.g. by supplying an activation signal to the brake 22, and a second point in time, at which the brake 22 is fully engaged, preventing any movement of the elevator car 6.

Similarly, the release time of the brake 22 may be defined as the time period between a third point in time at which the brake 22 is instructed to release, e.g. by supplying a deactivation signal to the brake 22 or by deactivating the activation signal, which has been supplied to the brake 22, and a fourth point in time, at which the brake 22 is released, allowing movement of the elevator car 6.

The brake monitoring system 221 further includes an brake counter 224, which is configured for increasing a counter value of the brake counter 224 every time the brake monitor 223 issues a notification indicating that the at least one operational parameter, which is monitored by the brake monitoring system 221, is outside the predefined parameter range.

The brake monitoring system 221 also includes an brake comparator 225 and an brake alert generator 226. The brake comparator 225 is configured for comparing the counter value of the brake counter 224 with a predefined brake counter limit. The brake alert generator 226 is configured for issuing an alert in case the counter value of the brake counter 224 exceeds the predefined brake counter limit,

The alert may include an brake maintenance message requesting maintenance of the elevator system 2, in particular maintenance of the brake 22.

In an alternative embodiment, the brake counter 224 may be configured for decreasing the counter value every time the brake monitor 223 issues a notification indicating that the at least one operational parameter, which is monitored by the brake monitoring system 221, is outside the predefined parameter range.

In such a configuration, the brake alert generator 226 is configured for issuing an alert, in particular including a brake maintenance message requesting maintenance of the elevator system 2, more particularly maintenance of the brake 22, in case the counter value of the brake counter 224 falls below predefined brake counter limit. The predefined brake counter limit may, in particular, be zero.

The brake monitoring system 221 may be configured for resetting the brake counter 224 to a starting value, when the counter value of the brake counter 224 exceeds the predefined brake counter limit or when the counter value of the brake counter 224 falls below the predefined counter limit.

The brake monitoring system 221 may be configured for resetting the brake counter 224 to a starting value, when after the alert has been issued and/or after a maintenance has been performed.

The brake counter 224 may be reset, for example, by the brake comparator 225, when the counter value of the brake counter 224 exceeds or falls below the predefined brake counter limit.

The brake counter 224 may be reset, for example, by the brake alert generator 226 after the brake maintenance message has been issued and/or after a maintenance has been performed.

Alternatively, the brake counter 224 may be reset manually by a mechanic after maintenance of the elevator system 2 has been completed.

Optionally, the brake counter 224 may be reset automatically in case no notification has been issued for a predefined period of time.

As a further option, the brake counter 224 may be reset automatically in case less than a predefined number of notifications have been issued in a predefined amount of time.

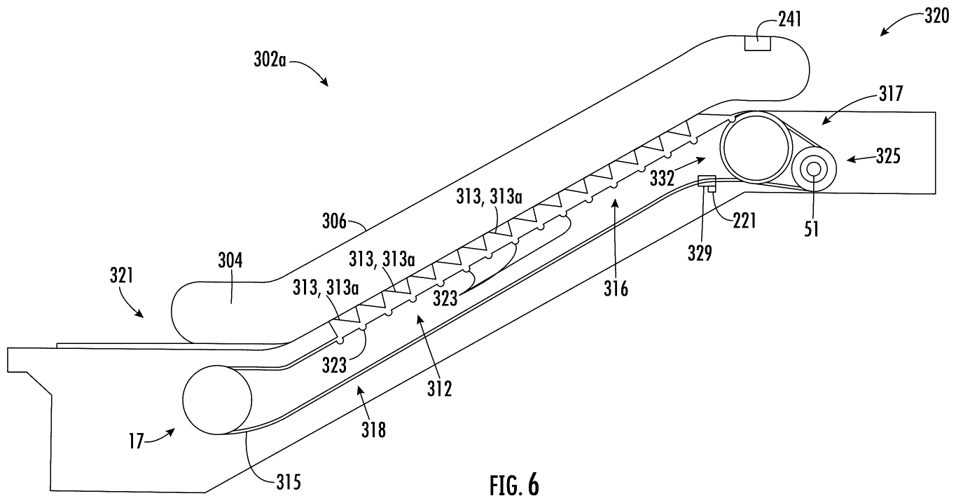

FIG. 6 shows a schematic side view of an escalator 302a, comprising a chain 312 of conveyance elements 313 or steps 313a extending in a longitudinal conveyance direction between two landings 320, 321. The conveyance elements 313 comprise rollers 323 which are guided and supported by guide rails. The guide rails not shown in FIG. 6.

In two turnaround portions 317, which are located next to the landings 320, 321, the chain 312 of conveyance elements 313 passes from a conveyance portion 316 into a return portion 318, and vice versa.

For clarity, only some of the conveyance elements 313, in particular conveyance elements 313 in the conveyance portion 316, are depicted in FIG. 6. Further, not all conveyance elements 313 and rollers 323 are denoted with reference signs.

A drive belt 315 extending along a closed loop is connected to the chain 312 of conveyance elements 313. The drive belt 315 is a toothed belt with teeth formed at least on the inner side of the loop. The drive belt 315 is in engagement with and driven by at least one toothed sheave 332 arranged in one of the turnaround portions 317. A drive 325, which may be denoted as chain drive 325, is configured for driving the toothed sheave 332.

The people conveyor 302a, 302b further comprises a chain brake 329 which is configured for braking movement of the chain 312 of conveyance elements 313. The chain brake 329 may engage with the toothed sheave 332 or a shaft of the toothed sheave 332. The chain brake 329 is depicted separately from the drive 325 in FIG. 6. The chain brake 329 may also be integrated with the drive 325.

Balustrades 304 supporting moving handrails 306 extend parallel to the conveyance portion 316. Only one of the balustrades 304 is visible in the side view shown in FIG. 1.

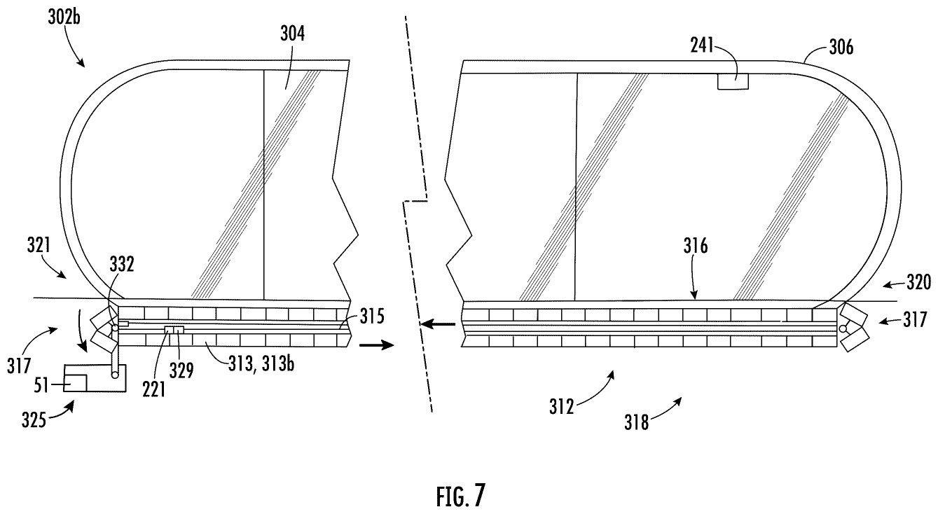

FIG. 7 depicts a schematic side view of a moving walkway 302b.

The moving walkway 302b comprises an endless chain 312 of conveyance elements 313 or pallets 313b moving in a longitudinal conveyance direction in an upper conveyance portion 316 and opposite to the conveyance direction in a lower return portion 318.

Landings 320, 321 are provided at both ends of the moving walkway 302b. In two turnaround portions 317, which are located next to the landings 320, 321, the chain 312 of conveyance elements 313 passes from the conveyance portion 316 into the return portion 318, and vice versa. Again, for clarity not all conveyance elements 313 or pallets 313b are provided with reference signs.

Balustrades 304 supporting moving handrails 306 extend parallel to the conveyance portion 316 on both lateral sided of the chain 312 of conveyance elements 313. Only one of the balustrades 304 is visible in the side view depicted in FIG. 7.

Similar to the embodiment shown in FIG. 6, the chain 312 of conveyance elements 313 is connected with a toothed endless drive belt 315. In at least one of the turnaround portions 317 the endless drive belt 315 is in engagement with a toothed sheave 332. When the moving walkway 302b is operated, the toothed sheave 332 is driven by a drive 325 for driving the chain 312 of conveyance elements 313.

The moving walkway 302b further comprises a chain brake 329 which is configured for braking movement of the chain 312 of conveyance elements 313. Although depicted separately, the chain brake 329 may also be integrated with the drive 325.

The drive 325 of the escalator 302a and the drive 325 of the moving walkway 302b may be equipped with a drive monitoring system 51, which is configured for monitoring the operation of the respective drive 325, as it has been described before for the example of an elevator drive 5 with reference to FIG. 2.

The description of the operation of the drive monitoring system 51 provided with reference to FIG. 2 for the example of an elevator drive 5 correspondingly applies to operating the drive monitoring system 51 for monitoring the operation of the drive 325 of the escalator 302a depicted in FIG. 6 and for monitoring the operation of the drive 325 of the moving walkway 302b depicted in FIG. 7, respectively.

The chain brake 329 of the escalator 302a as well as the chain brake 329 of the moving walkway 302b may be provided with an brake monitoring system 221, which is configured for monitoring the operation of the chain brake 329, as it has been described before for the example of an elevator brake 22 with reference to FIG. 5.

The description of the operation of the brake monitoring system 221 provided with reference to FIG. 2, for the example of an elevator brake 22, correspondingly applies to operating the brake monitoring system 221 for monitoring the operation of the chain brake 329 of the escalator 302a, depicted in FIG. 6, and for monitoring the operation of the chain brake 329 of the moving walkway 302b depicted in FIG. 7, respectively.

Additionally or alternatively, at least one handrail 306 of the escalator 302a and/or at least one handrail 306 of the moving walkway 302b may be equipped with a handrail monitoring system 241, which is configured for monitoring the movement of the respective handrail 306.

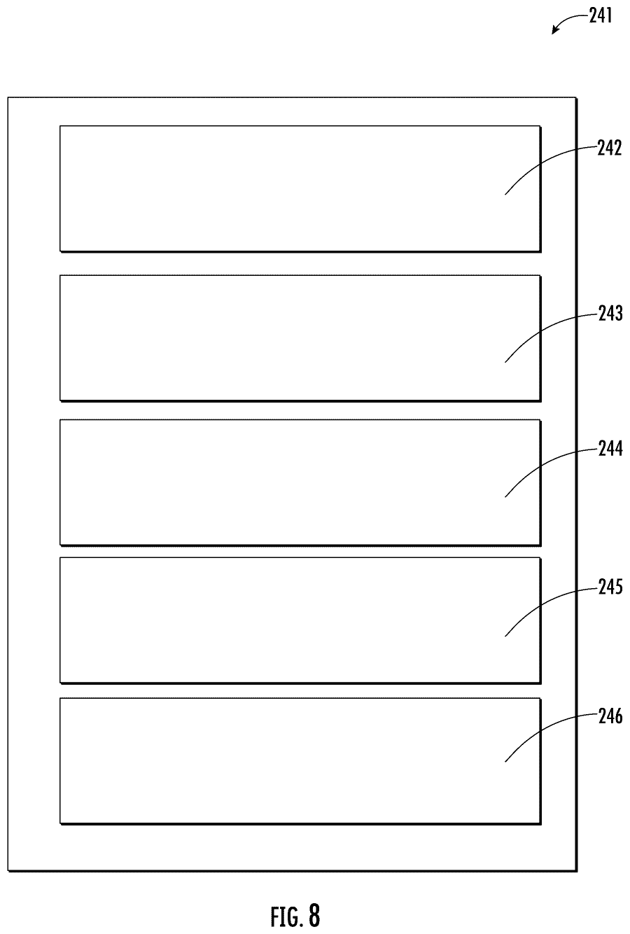

An enlarged schematic view of a handrail monitoring system 241 according to an exemplary embodiment of the disclosure is depicted in FIG. 8.

The handrail monitoring system 241 includes a handrail detector 242, which is configured for detecting at least one operational parameter of the handrail 306. The handrail detector 242 may, for example, be configured for detecting a speed of the handrail 306. Alternatively, the handrail detector 242 may be configured for detecting an acceleration of the handrail 306, in particular when the escalator 302 or moving walkway 302b is activated or deactivated.

The handrail monitoring system 241 further includes a handrail monitor 243, which is configured for checking whether the at least one operational parameter, which is detected by the handrail brake detector 242, is outside a predefined parameter range. The predefined parameter range may, for example, define range of allowable speeds of the handrail 306.

The predefined parameter range may be limited at both ends, i.e. at its upper end and at its lower end. Alternatively, the predefined parameter range may be limited at only one end, in particular at its upper end, so that a notification is issued by the handrail monitoring system 241 in case the at least one operational parameter exceeds a predefined limit, which corresponds to the upper end of the predefined parameter range.

The handrail monitoring system 241 may further be configured for comparing the speeds of the two handrails 306 of the escalator 302 or of the moving walkway 302b, respectively, and the at least one operational parameter may include the speed difference of the movements of the two handrails 306.

The handrail brake monitor 243 is further configured for issuing a notification in case the at least one operational parameter is outside the predefined parameter range.

The handrail brake monitoring system 241 further includes a handrail brake counter 244, which is configured for increasing a counter value of the handrail counter 244 every time the handrail monitor 243 issues a notification indicating that the at least one operational parameter, which is monitored by the handrail monitoring system 241, is outside the predefined parameter range.

The handrail monitoring system 241 also includes a handrail comparator 245 and a handrail alert generator 246. The handrail comparator 245 is configured for comparing the counter value of the handrail counter 224 with a predefined handrail counter limit. The handrail alert generator 246 is configured for issuing an alert in case the counter value of the handrail counter 224 exceeds the predefined handrail counter limit. The alert may in particular include a handrail maintenance message requesting maintenance of the escalator 302 or of the moving walkway 302b, respectively, in particular maintenance of the handrail 306 of the escalator 302 or of the moving walkway 302b.

In an alternative embodiment, the handrail counter 244 may be configured for decreasing the counter value every time the handrail monitor 243 issues a notification indicating that the at least one operational parameter, which is monitored by the handrail monitoring system 241, is outside the predefined parameter range.

In such a configuration, the handrail alert generator 246 is configured for issuing an alert, in particular including a handrail maintenance message requesting maintenance of the escalator 302 or of the moving walkway 302b, more particularly maintenance of the handrail 306, in case the counter value of the handrail counter 244 falls below predefined handrail counter limit. The predefined handrail counter limit may, in particular, be zero.

The handrail monitoring system 241 may be configured for resetting the handrail counter 244 to a starting value, when the counter value of the handrail counter 244 exceeds the predefined handrail counter limit or when the counter value of the handrail counter 244 falls below the predefined handrail counter limit.

The handrail monitoring system 241 may be configured for resetting the handrail counter 244 to a starting value, when after the alert has been issued and/or after a maintenance has been performed.

The handrail counter 244 may be reset, for example, by the handrail comparator 245, when the counter value of the handrail counter 244 exceeds or falls below the predefined elevator handrail counter limit.

The handrail counter 244 may be reset, for example, by the handrail alert generator 246 after the alert has been issued and/or after a maintenance has been performed.

Alternatively, the handrail counter 244 may be reset manually by a mechanic after maintenance of the escalator 302 or of the moving walkway 302b has been completed.

Optionally, the handrail counter 244 may be reset automatically in case no notification has been issued for a predefined period of time. As a further option, the handrail counter 244 may be reset automatically in case less than a predefined number of notifications have been issued in a predefined amount of time.

The parameters, which have been explicitly mentioned in the forgoing description for being monitored by a monitoring system and a method according to exemplary embodiments of the disclosure are only provided as examples. A monitoring system and a method for predicting the need for maintenance of at least one component of a people conveyor 302a, 302b may be similarly applied to other parameters of the people conveyor 302a, 302b, even of these parameters have not been mentioned explicitly in the forgoing description. Further parameters may, for example, include the speed of the elevator car 6 and/or the speed of the chain 312 of conveyance elements 313.

### REFERENCES

2 elevator system
3 tension member
4 hoistway
5 elevator drive
6 elevator car
7a elevator hall call button
7b elevator cat control button
8 landing
10 landing door
11 elevator car door
15 elevator control
16 guide member
17 corresponding scale
18 positioning system
19 position sensor
20 door drive
22 elevator brake
23 door senor
30 passenger
51 drive monitoring system
52 drive detector
53 drive monitor
54 drive counter
55 drive comparator
56 drive alert generator
181 positioning system monitoring system
182 positioning system detector
183 positioning system monitor
184 positioning system counter
185 positioning system comparator
186 positioning alert generator
201 door drive monitoring system
202 door drive detector
203 door drive monitor
204 door drive counter
205 door drive comparator
206 door alert generator
221 brake monitoring system
222 brake detector
222 brake monitoring detector
223 brake monitor
224 brake counter
225 brake comparator
226 brake alert generator
241 handrail monitoring system
242 handrail detector
243 handrail monitor
243 handrail brake monitor
244 handrail brake counter
244 handrail counter
245 handrail comparator
246 handrail alert generator
302a escalator
302b moving walkway
304 balustrade
306 handrail
312 chain of conveyance elements
313 conveyance element
313a steps
313b pallets
315 drive belt
316 conveyance portion
318 return portion
320, 321 landings
223 rollers
325 chain drive
329 chain brake
332 toothed sheave

1. A monitoring system for predicting the need for maintenance of at least one component of an elevator system or of a people conveyor, the monitoring system comprising:
at least one detector that detects or measures at least one operational parameter of at least one operation of the at least one component;
at least one monitor that checks whether the at least one operational parameter is outside at least one predefined parameter range;
at least one counter that increases or decreases at least one counter value in case the at least one operational parameter is outside the at least one predefined parameter range;
at least one comparator that compares the at least one counter value with at least one predefined counter limit; and
at least one alert generator that issues an alert if the at least one counter value exceeds or falls below the at least one predefined counter limit.

2. The monitoring system according to claim 1, wherein the at least one predefined counter limit is based on a factory created model of the elevator system or the people conveyor, and/or on a history of the elevator system or the people conveyor.

3. The monitoring system according to claim 1, wherein the monitoring system resets the at least one counter after a counter value has exceeded or fallen below the at least one predefined counter limit.

4. The monitoring system according to claim 1, wherein the monitoring system resets the at least one counter after the alert has been issued and/or after a maintenance has been performed.

5. The monitoring system according to claim 1, wherein the monitoring system resets the at least one counter (54, 184, 204, 224, 244) in case no notification has been issued for a predefined period of time or in case less than a predefined number of notifications have been issued in the predefined period of time.

6. The monitoring system according to claim 1, wherein the at least one operation of the at least one component includes at least one of:
operating a brake of the elevator system or of the people conveyor, wherein the at least one operational parameter includes an activation time and/or a release time of the brake;
moving a door of the elevator system, and wherein the at least one operational parameter includes an opening time and/or a closing time of the door;
operating a drive of the elevator system or of the people conveyor, wherein the at least one operational parameter includes an electric current flowing through an electric motor of the drive;
positioning an elevator car of the elevator system at a predefined position, wherein the at least one operational parameter includes a distance between an actual position of the elevator car and the predefined position of the elevator car;
moving a handrail of the people conveyor, wherein the at least one operational parameter includes a speed and/or an acceleration of the handrail.

7. The monitoring system according to claim 1, wherein the at least one detector comprises multiple detectors that detect or measure different operational parameters of one or more operations of one or more components.

8. A people conveyor, in particular an escalator or a moving walkway, comprising:
at least one movable conveyance component that conveys passengers between a plurality of landings; and
at least one monitoring system according to any claim 1.

9. An elevator system comprising:
at least one elevator car, which is movable as a movable conveyance component along a hoistway between a plurality of landings to convey passengers between the plurality of landings;
at least one monitoring system according to claim 1.

10. A method for predicting a need for maintenance of at least one component of an elevator system or of a people conveyor by monitoring at least one operational parameter of the at least one component of the elevator system or of the people conveyor, the method comprising repeatedly:
detecting or measuring at least one operational parameter of at least one operation of the at least one component;
checking whether the at least one operational parameter is outside at least one predefined parameter range;
increasing or decreasing at least one counter value of at least one counter in case the at least one operational parameter is outside the at least one predefined parameter range;
comparing the at least one counter value with at least one predefined counter limit; and
issuing an alert if the at least one counter value exceeds or falls below the at least one predefined counter limit.

11. The method according to claim 10, including resetting the at least one counter after a counter value has exceeded or fallen below the at least one predefined counter limit.

12. The method according to claim 10, including resetting the at least one counter after the alert has been issued and/or after a maintenance has been performed.

13. The method according to claim 10, including resetting the at least one counter in case no notification has been issued for a predefined period of time or in case less than a predefined number of notifications have been issued in the predefined period of time.

14. The method according to claim 10, wherein the at least one operation of the at least one component includes at least one of:
operating a brake of the elevator system or of the people conveyor, wherein the at least one operational parameter includes an activation time and/or a release time of the brake;
moving a door of the elevator system, wherein the at least one operational parameter includes an opening time and/or a closing time of the door;
operating a drive of the elevator system or of the people conveyor wherein the at least one operational parameter includes an electric current flowing through an electric motor of the drive;
positioning an elevator car of the elevator system at a predefined position, wherein the at least one operational parameter includes a deviation of an actual position of the elevator car from the predefined position of the elevator car; and
moving a handrail of the people conveyor, wherein the at least one operational parameter includes a speed and/or an acceleration of the handrail.

15. The method according to claim 10, including monitoring multiple operational parameters of one or more operations of one or more components of the elevator system or of the people conveyor.

16. The people conveyer according to claim 8, wherein the at least one monitoring system comprises a plurality of monitoring systems that monitor different operational parameters of one or more components of the people conveyor.

17. The elevator system according to claim 9, wherein the at least one monitoring system comprises a plurality of monitoring that monitor different operational parameters of one or more components of the elevator system.
